(19) United States
(12) Patent Application Publication
(10) Pub. No.: US 2016/0077588 A1
(43) Pub. Date: Mar. 17, 2016

(54) SWITCH ARRAY UTILIZING TOUCH SCREEN TECHNOLOGY AND HAPTICS FEEDBACK

(71) Applicant: Continental Automotive Systems, Inc., Auburn Hills, MI (US)

(72) Inventors: Orthell LaVount Adams, Ypsilanti, MI (US); Eluid David Carter, West Bloomfield, MI (US); Michael J. Hartmeyer, West Bloomfield, MI (US); Arthur S. Brown, Sterling Heights, MI (US); Daniel Arthur Brudzynsky, Waterford, MI (US)

(21) Appl. No.: 14/483,932

(22) Filed: Sep. 11, 2014

(51) Int. Cl. G06F 3/01; G06F 3/044; H01H 13/14

(52) U.S. Cl. CPC G06F 3/016; H01H 13/14; G06F 3/044; H01H 2207/04; H01H 2215/00; H01H 2231/00; H01H 2219/032

(57) ABSTRACT

A reconfigurable switch array assembly incorporating a touch screen system and haptics feedback that sends a signal for executing desired functions selected by a user and that alerts an operator by providing mechanical feedback. Graphics viewable on the touch screen and desired functions are reconfigurable utilizing module software compatible for selectively providing several different graphical and/or functional configurations contained in a single package. The reconfigurable switch array assembly has a rocker button that moves to a downward and upward position. When a user touches the desired function's graphic a capacitive field is created by a capacitive film to identify the desired function. The rocker button rotates from a static position to a downward or upward position caused by the force of the user's touch, which actuates a tactile switch to perform the selected function.

### FIELD OF THE INVENTION

The present invention relates to interior instrumentation displays, more particularly, to an interior instrumentation display with operator control interface for motor vehicles that alerts the operator that an operator command requesting specific action to be performed by the vehicle has been selected and performs multiple requested functions.

### BACKGROUND OF THE INVENTION

Motor vehicles sometimes employ in-vehicle displays incorporating operator input to perform different functions when desired. There have been various systems which are used to achieve the use of operator input display systems, one of which is to incorporate the use of a straight push actuation. These systems are commonly located in the instrument panel of the vehicle. Typically, these systems incorporate graphical interface with buttons and use response feedback. However, the systems consisting of straight push actuation use a higher cost clicker module to provide response feedback. With existing systems, multiple packages with different configurations (i.e., buttons, foil films, appliques, etc) would be required for different graphical and functional requirements.

Accordingly, there exists a need to provide a lower cost and simpler design for a haptic feedback solution and to allow for the reconfiguration of the desired graphical and functional representation in a single mechanical module.

### SUMMARY OF THE INVENTION

The present invention is directed to a reconfigurable switch array module utilizing a touch screen and haptics feedback that alerts an operator by providing mechanical feedback. The present invention features a mechanical rocking motion that utilizes a capacitive touch screen arrangement and correlated tactile switches for mechanical feedback. The touch screen is also suitably reconfigurable utilizing module software compatible for selectively providing several different graphical and/or functional configurations contained in a single package. Allowing reconfiguration of the desired graphical and functional representation in a single mechanical module also provides an efficient and cost effective interchangeable interface and haptic feedback solution. In operation the desired function is identified by capacitive touch, then the desired function is executed by a signal sent as the result of the actuation of the tactile switch which also provides a tactile feedback. The present invention is simpler, provides singular mechanical control solution utilizing capacitive touch features, and has a lower mechanical tolerance stack up.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a front elevation view of a switch array assembly incorporating exemplary reconfigurable switch array graphics for providing climate control in an activated state, in accordance with the present invention;

FIG. 2 is a front elevation view of the switch array assembly incorporating second exemplary reconfigurable switch array graphics for providing climate control in an activated state, in accordance with the present invention;

FIG. 3 is an exploded view of a reconfigurable switch array assembly, in accordance with the present invention,

FIG. 4 is a perspective view of the reconfigurable switch array assembly showing a rocker button actuateable in both directions about a horizontal axis, in accordance with the present invention;

FIG. 5 is a perspective view of the reconfigurable switch array assembly with the rocker button in a static/resting position, in accordance with the present invention;

FIG. 6 is a perspective view of the reconfigurable switch array assembly with the rocker button in a downward actuated position, in accordance with the present invention;

FIG. 7 is a perspective view of the reconfigurable switch array assembly with the rocker button in an upward actuated position, in accordance with the present invention;

FIG. 8 is a perspective broken-away view of the reconfigurable switch array assembly illustrating activation upon an operator touching a desired function's graphic and a capacitive field created by a capacitive film identifies the desired function; and

FIG. 9 is a perspective broken-away view of the reconfigurable switch array assembly with the rocker button actuating in an upward direction in response to the operator's selection to actuate a tactile switch to execute the desired function, in accordance with the present invention.

### DETAILED DESCRIPTION OF THE PREFERRED EMBODIMENTS

The following description of the preferred embodiment(s) is merely exemplary in nature and is in no way intended to limit the invention, its application, or uses.

The present invention generally provides a singular mechanical control solution which utilizes capacitive features in combination with a haptic feedback. In particular, capacitive touch screen system in combination with mechanical feedback. A composite rocker button design solution features a mechanical rocking motion that utilizes capacitive touch screen features and tactile switches for the mechanical feedback. The present invention also allows for a graphical and functional reconfiguration of the touch screen via module software allowing for a single mechanical module. Thus, the switch array control of the present invention includes multiple interchangeable graphic and functional configurations in a single package. The composite rocker button, or rocker button or rocker button actuating assembly used interchangeably herein, selectively performs multiple functions. These functions are determined by the identifying graphics indicating where an operator is to press for requesting a specific function. The function activation is done in a two part sequence. First, the operator touches the desired function's graphic as indicated on the touch screen and a capacitive film identifies the function. Next, the composite rocker button rocks due to the force that is applied by the operator. This results in a tactile switch being actuated and sends a signal to execute the desired function.

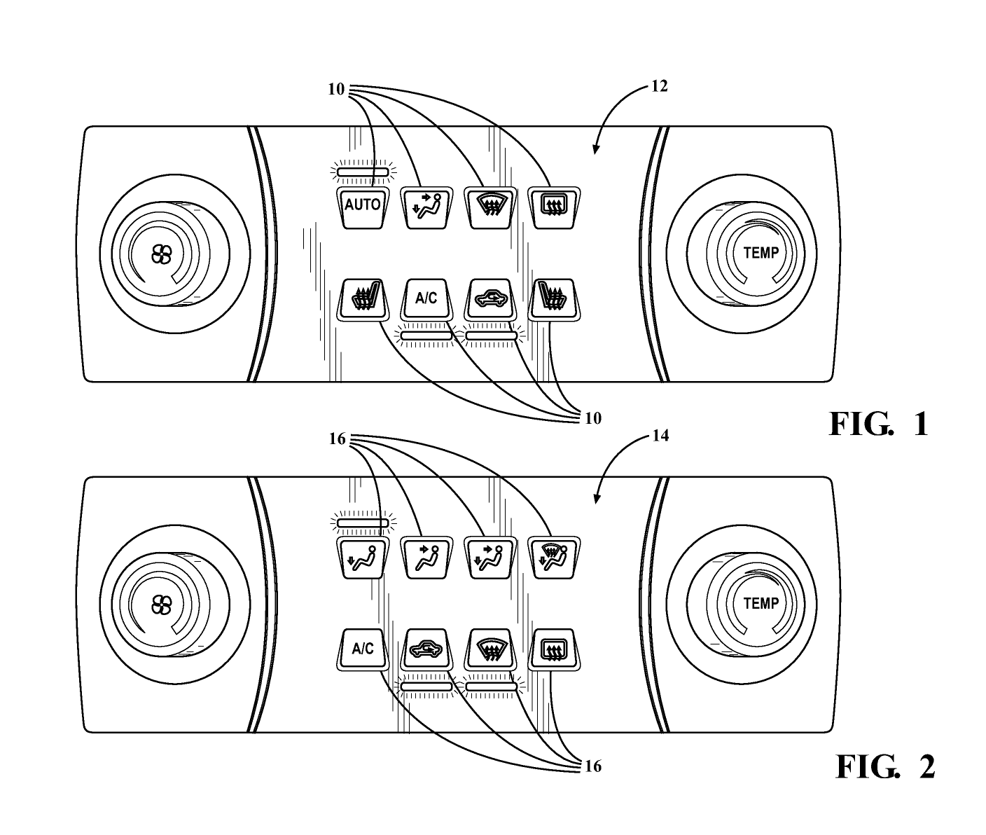

Referring to FIGS. 1-2 generally, there is illustrated an example of application with a climate control system. FIG. 1 is an elevation view of a climate control module. These modules are commonly located in the instrument panel of a vehicle. There is depicted an exemplary reconfigurable switch array graphics for providing climate control with selected graphics shown in an activated or “on” state. An operator selects by touch one or more of the desired functions correlating with the respective graphic 10, e.g., air conditioning, air recirculation, defrosters, automatic, etc, displayed on a capacitive touch screen, shown generally at 12. The desired function is executed by a signal sent as a result of actuation of the tactile switch which also provides a tactile feedback. FIG. 2 is an alternative exemplary reconfigurable switch array graphics arrangement viewable on the capacitive touch screen, shown generally at 14, to illustrate reconfiguration of the climate control graphics 16 and functions with respect to those depicted in FIG. 1, e.g., no heated seats and having additional air directing options. It is understood that the reconfigurable switch array graphics is not limited to climate control applications and can be alternatively operably reconfigured and combinable with alternative systems, e.g., radios, media modules, navigation, rear assist camera modules, and any other instrument panel electronics, suitable to meet automotive specifications and functionality.

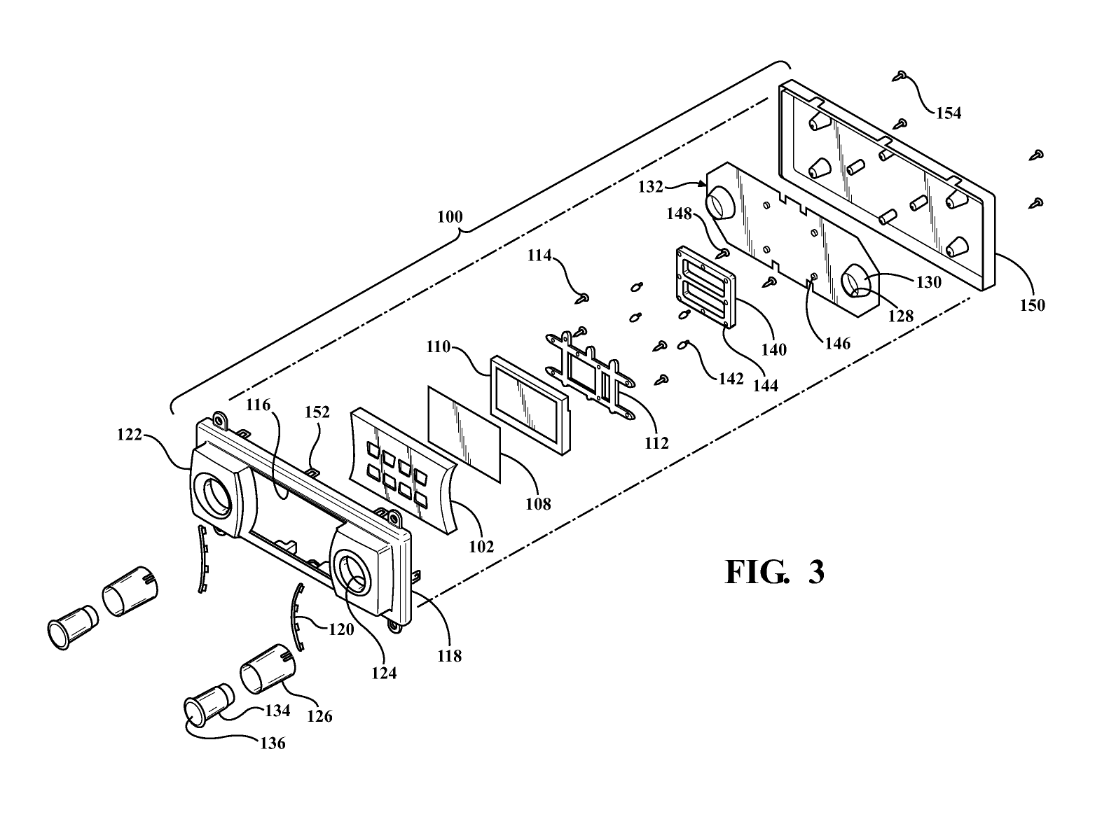

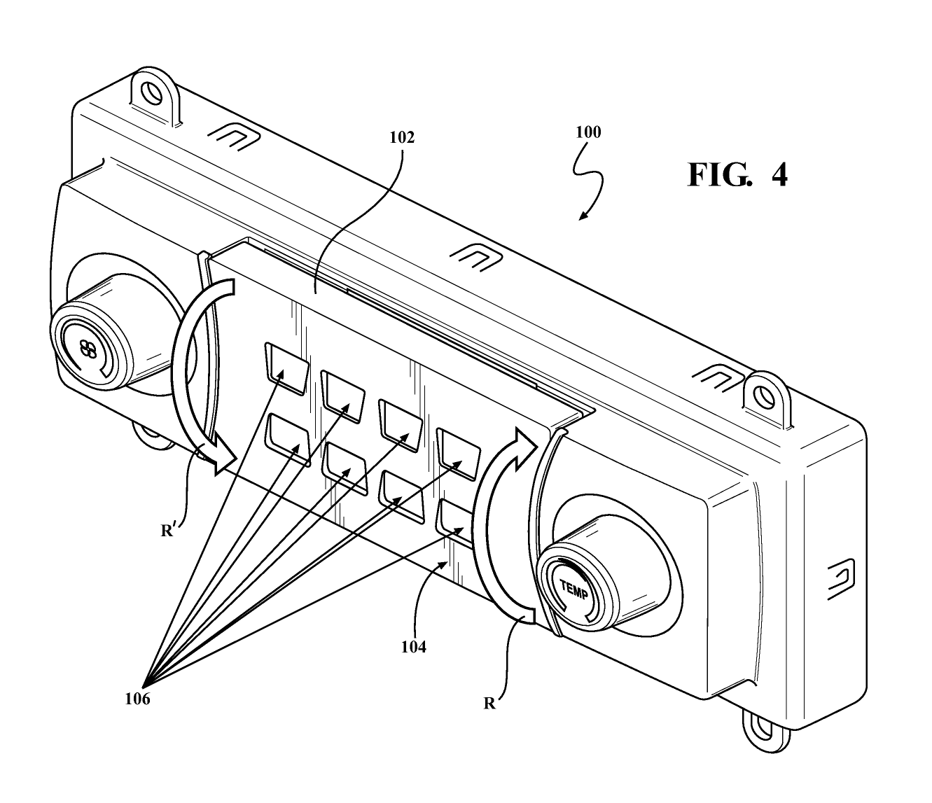

Referring to FIGS. 3-9 generally, there is provided a reconfigurable switch array assembly, shown generally at 100, having a rocker button 102 operably mounted for rotatable movement in both directions about a horizontal axis along the centerline of the reconfigurable switch array assembly 100 (as depicted by actuation direction arrows R,R′ in FIG. 4). The rocker button 102 is operably configured to allow performance of a plurality of functions. These functions are identified by a plurality of graphics on a touch screen, shown generally at 104, indicating where an operator is to press for selecting one or more functions. Preferably, the touch screen 104 of the rocker button 102 has a plurality of functional nodes, shown generally at 106, providing recessed finger landing areas for an operator or occupant user to select the desired function. The operator touches the desired function's graphic as indicated on the touch screen 104, e.g., each graphic is viewable and selectable within a respective functional node 106, and a capacitive field is created identifying the requested function.

A capacitive sense film 108 is in operational contact with the rocker button 102 and a thin film transistor 110. Generally, the thin film transistor (TFT) 110 is a color TFT display, typically, a color TFT liquid crystal display (LCD), most preferably, a 4.2 inch color TFT LCD. An LCD display retainer 112 is located against the rear of the TFT 110 and is coupled to the rear of the rocker button 102 and/or the TFT 110 using a plurality of fasteners 114, e.g., screws. This holds the front of the TFT 110 against the rear of the capacitive sense film 108 and holds the front of the capacitive sense film 108 in functional engagement with the touch screen 104, e.g., such that each predetermined graphic transmitted by the TFT 110 is viewable within one or more respective plurality of functional nodes 106 of the rocker button 102. When an operator touches the desired function's graphics as indicated on the touch screen 104 the capacitive sense film 108 identifies the function.

The rocker button 102 is located within an opening 116 provided in a bezel frame 118 that does not move and has class A surfaces. Preferably, the reconfigurable switch array assembly 100 also has at least two accent panels 120, e.g., thinner chrome accents, operably mounted within the opening 116 flush between both ends of the rocker button 102 and the rocker button 102. Preferably, the bezel frame 118 is provided with at least two raised portions 122 each having a respective aperture 124 both sized to receive a portion of a knob 126 therein. The pair of knobs 126 partially extend through the apertures 124 and are in physical and electrical contact with a printed circuit board assembly (PCBA), shown generally at 132, for executing additional functions. The pair of knobs 126 snap onto encoders 130 formed on the PCBA 132.

The pair of knobs 126 are also generally cylindrical and each receive a smaller diameter portion of a respective knob cap 134 therein. The knob caps 134 snap into a pair of openings 128 in encoders 130. A larger diameter outer portion 136 of the knob caps 134, e.g., a generally flat mushroom like portion, having an identical outer diameter as each knob 126 seals off the open end of the cylindrical knobs 126. The knobs 126 are rotatable to allow further operator desired functions, e.g., temperature variations.

The rocker button 102 is mounted with respect to a plurality of tactile switches, generally shown at 146. When the rocker button 102 rocks due to the force that is applied to it by the operator touching the functional node 106 associated with the desired function's graphic, the respective tactile switch 146 is actuated to execute that desired function. There is provided a tappet housing 140 coupled to the rear of the LCD display retainer 112 using a second plurality of fasteners 148, e.g., at least two screws. The tappet housing 140 has a plurality of tappets 142 extending through a plurality of apertures 144 operably spaced in the tappet housing. The plurality of tappets 142 are operably aligned with the plurality of tactile switches 146 that are surface mounted on the PCBA 132. The plurality of tappets 142 extend through the tappet housing 140 for selectively contacting, at contact area shown generally at 138, the plurality of tactile switches 146 as the rocker button 102 rocks in the direction (R or R′) directly associated with the operator selected function. This results in the respective tactile switch 146 being actuated by physical and electrical contact between the particular tappet 142 and tactile switches 146 which allows an electrical signal to execute the desired function.

A rear cover 150 is provided for connecting to the bezel frame 118 to form a housing. The rear cover 150 is aligned with and connected to the bezel frame 118 using a snap fit engagement with a plurality of connection tabs 152 on the bezel frame 118 and a third plurality of fasteners 154, e.g., at least four screws, to connect the rear cover 150 to the bezel frame 118.

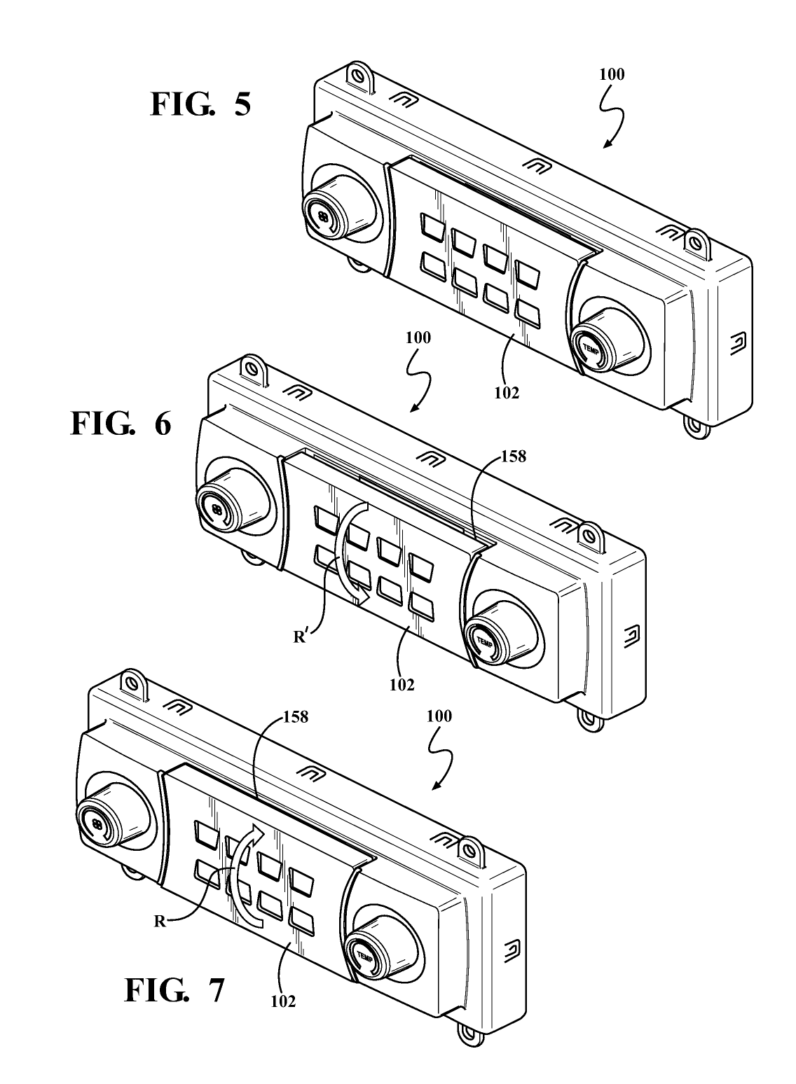

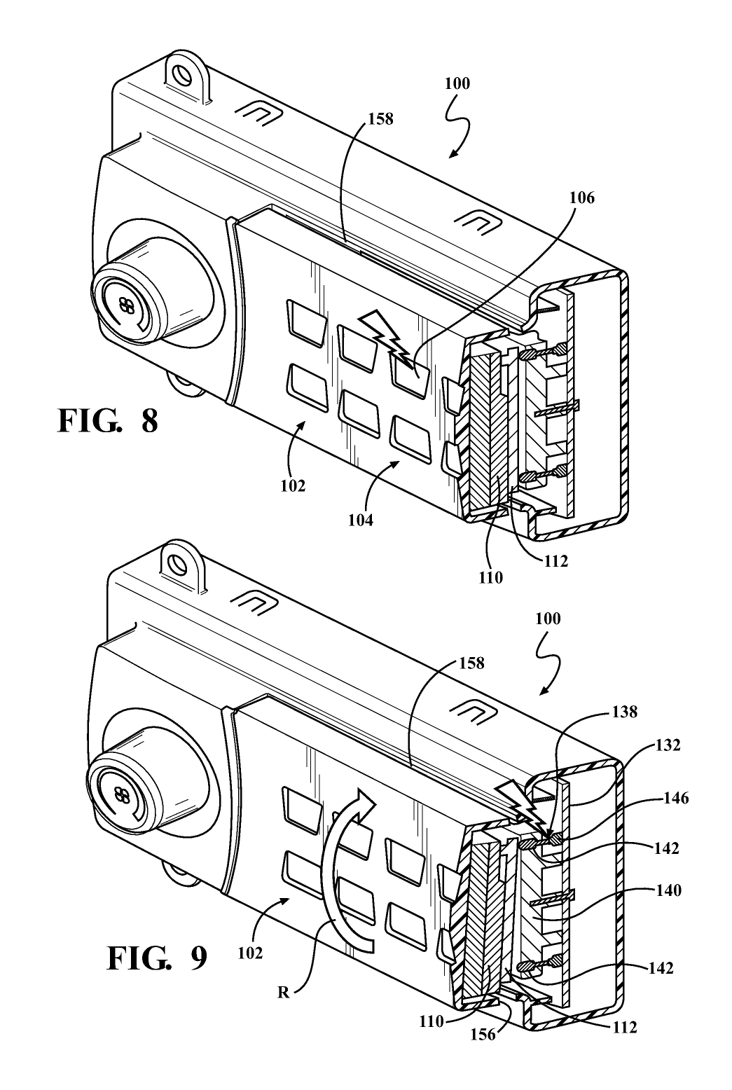

Referring more particularly to FIGS. 5-9, the rocker button 102 is actuatable between a downward actuated position (FIG. 6) and an upward actuated position (FIG. 7). After actuation the rocker button 102 returns to the neutral position (FIG. 5) with the force of the tactile switch 146. In the neutral or static, resting position there is no air gap between the plurality of tappets 142 and the plurality of tactile switches 146 (FIG. 8). As the rocker button 102 actuates to the downward position an upper air gap 158 between the rocker button 102 and bezel frame 118 increases, and a lower air gap 156 disposed between a lower portion of the rocker button 102 and the bezel frame 118 decreases until the respective lower tactile switch 146 is actuated to execute the operator selected desired function. Conversely, as the rocker button 102 actuates to the upward position the lower gap 156 increases, and the upper air gap 158 between the rocker button 102 and bezel frame 118 decreases until the respective upper tactile switch is actuated to execute the desired function.

In operation, the operator touches the desired function's graphics and a capacitive field created by the capacitive sense film 108 identifies the desired function. The rocker button 102 rocks in a particular direction in response to the force applied to it by the operator. This will actuate the respective tactile switch 146 to execute the desired function. After the rocker button 102 is actuated in either the upward and downward directions the rocker button 102 returns to the neutral position with the force of the tactile switch 146.

The reconfigurable switch array assembly 100 comprises a large composite rocker button 102 that performs a plurality of functions. These functions are determined by the identifying graphics indicating where an operator is to press for the desired function. The function activation is done in a two-part sequence. The operator touches the desired function's graphic as indicated on the touch screen and the capacitive film 108 identifies the function. The composite rocker button 102 rocks due to the force that is applied by the operator touching the touch screen. This results in a tactile switch being actuated and sends a signal to execute the desired function. Thus, the desired function is identified by capacitive touch and the desired function is executed by a signal sent as the result of the actuation of the tactile switch which also provides a tactile feedback. The combination of a capacitive touch system and mechanical feedback, e.g., rotation of the rocker button 102 up and down, is significantly beneficial over conventional assemblies. The reconfigurability of the desired graphical functions of the control is also significantly beneficial. Yet another significant advantage is providing of a more simple, singular mechanical control solution utilizing a capacitive touch system. The switch array assembly 100 with multiple predetermined interchangeable graphic and functional configurations in a single package has significant benefits for vehicle applications such as interior instrumentation displays/HMI (human machine interface) control over conventional assemblies.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A switch array assembly, comprising:
a rocker button incorporating a capacitive touch system,
a bezel frame with an opening, said rocker button operably coupled within said opening and rotatable with respect to said bezel frame when actuated between a static position, downward position and upward position;
a touch screen portion having an interchangeable user interface;
a capacitive sense film operably responsive to capacitive touch of said touch screen by a user which identifies user selection of at least one of a plurality of desired functions viewable on said touch screen, where actuation of said rocker button caused by said user's touch rotates said rocker button from said static position to said downward or upward position providing haptic feedback to said user;
a circuit board operably connected to at least said rocker button; and
a plurality of tactile switches operably connected to at least said circuit board, where rotation of said rocker button to said downward or upward position actuates at least one of said plurality of tactile switches sending a signal to execute said user's selected desired function.

2. The switch array assembly of claim 1, further comprising a plurality of tappets operably coupled to said rocker button wherein each of said plurality of tappets is operably aligned with a respective one of said plurality of plurality of tactile switches.

3. The switch array assembly of claim 2, wherein when said rocker button rotates to said upward position an upper air gap decreases as at least one of said tappets contacts a respective at least one of said plurality of tactile switches causing at least one of said tactile switches to actuate to execute the desired function(s).

4. The switch array assembly of claim 3, wherein when said rocker button rotates to said downward position a lower air gap decreases as at least one of said tappets contacts a respective at least one of said plurality of tactile switches causing at least one of said tactile switches to actuate to execute the desired function(s).

5. The switch array assembly of claim 4, wherein said plurality of tappets includes at least one upper tappet and at least one lower tappet and said plurality of tactile switches includes at least one lower tactile switch and at least one upper tactile switch, such that when said rocker button rotates to said upward position said at least one upper tappet in contact with said at least one upper tactile switch actuates said at least one upper tactile switch, and when said rocker button rotates to said downward position said lower tappet in contact with said at least one lower tactile switch actuates said at least one lower tactile switch.

6. The switch array assembly of claim 1, wherein said rocker button automatically returns to said static position after actuation of one of said plurality of tactile switches.

7. The switch array assembly of claim 6, wherein said rocker button is automatically returned to said static position by the force of the actuated tactile switch.

8. The switch array assembly of claim 1, wherein said touch screen has a plurality of functional nodes providing recessed finger landing areas.

9. The switch array assembly of claim 8, further comprising a plurality of graphics illustrating said plurality of desired functions, where said user touches at least one of said a plurality of functional nodes and a capacitive field created by said capacitive sense film identifies said desired function(s) selected by said user.

10. The switch array assembly of claim 9, wherein said plurality of graphics and plurality of desired function configurations are reconfigurable providing said interchangeable user interface.

11. The switch array assembly of claim 10, wherein reconfiguration of said touch screen portion includes utilizing module software compatible for providing several different graphical and/or functional configurations in a single mechanical module.

12. The switch array assembly of claim 1, wherein said plurality of desired functions is selected from the group consisting of air conditioning, air recirculation, temperature control, heated seat(s), heat location control, air conditioning location control, defroster(s), radio, multi-media control(s), navigation, voice command, mobile device control, connectivity demand control, rear assist camera modules, any other instrument panel electronics and rear passenger compartment electronics, and any combination thereof.

13. The switch array assembly of claim 1, wherein said circuit board is a printed circuit board assembly (PCBA) operably connected to a rear cover of said switch array assembly, wherein said PCBA is operably coupled to electrical wiring in operational contact with other components that execute said user's selected desired function(s).

14. The switch array assembly of claim 1, further comprising a thin film transistor located behind said capacitive sense film, and a liquid crystal display retainer where said liquid crystal display retainer is located adjacent the rear of said thin film transistor and is operably coupled against the rear of said rocker button using a plurality of fasteners.

15. The switch array assembly of claim 14, further comprising a tappet housing with a plurality of apertures and a plurality of tappets partly extending through said plurality of apertures for selectively actuating said plurality of tactile switches.

16. The switch array assembly of claim 15, wherein said tappet housing is operably connected to said liquid crystal display retainer using a second plurality of fasteners.

17. A reconfigurable switch array assembly, comprising:
a rocker button;
a bezel frame with an opening, said rocker button operably coupled within said opening and rotatable with respect to said bezel frame when actuated between a static position, downward position and upward position;
a touch screen portion having an interchangeable user interface including a plurality of functional nodes correlating with a plurality of graphics;
a capacitive sense film operably responsive to capacitive touch of said plurality of functional nodes by a user, where actuation of said rocker button caused by said user's touch rotates said rocker button from said static position to said downward or upward position providing haptic feedback to said user;
a printed circuit board operably coupled at least to said rocker button; and
a plurality of tactile switches operably connected to at least said printed circuit board, where rotation of said rocker button to said downward or upward position actuates at least one of said plurality of tactile switches sending a signal to execute said desired function(s) selected by said user;
wherein said plurality of graphics and plurality of desired function configurations are reconfigurable, said reconfiguration of said touch screen portion includes utilizing module software compatible for providing several different graphical and/or functional configurations in a single mechanical module.

18. The reconfigurable switch array assembly of claim 17, further comprising a plurality of tappets operably coupled to said rocker button and a plurality of tactile switches operably coupled to said circuit board, wherein when said rocker button rotates to said upward position at least one of said tappets in contact with a respective at least one of said tactile switches causes at least one of said plurality of tactile switches to actuate to execute the desired function(s), and wherein when said rocker button rotates to said downward position at least one of said plurality of tappets in contact with a respective at least one of said plurality of tactile switches causes at least one of said tactile switches to actuate to execute the desired function(s).

19. The switch array assembly of claim 1, wherein said rocker button automatically returns to said static position after actuation of one of said plurality of tactile switches.

20. A reconfigurable switch array assembly for a vehicle, comprising:
a rocker button incorporating a capacitive touch system;
a bezel frame with an opening, said rocker button operably coupled within said opening and rotatable with respect to said bezel frame when actuated between a static position, downward position and upward position;
a touch screen portion having a plurality of functional nodes and an interchangeable user interface including a plurality of graphics correlating to a plurality of desired functions;
a capacitive sense film operably responsive to capacitive touch of said plurality of functional nodes by said user, where actuation of said rocker button caused by said user's touch rotates said rocker button from said static position to said downward or upward position providing haptic feedback to said user;
a printed circuit board including a plurality of tabs, said printed circuit board operably coupled to at least said rocker button; and
a plurality of tactile switches including a plurality of tappets operably coupled to said rocker button,
wherein when said user touches at least one of said a plurality of functional nodes a capacitive field created by said capacitive sense film identifies said desired function(s) selected by said user; and
wherein when said rocker button rotates to said upward position at least one of said tappets in contact with a respective at least one of said tactile switches actuates at least one of said plurality of tactile switches sending a signal to execute said desired function(s), and wherein when said rocker button rotates to said downward position at least one of said plurality of tappets in contact with a respective at least one of said plurality of tactile switches actuates at least one of said tactile switches, sending a signal to execute said desired function(s).
